(19) United States
(12) Patent Application Publication
(10) Pub. No.: US 2009/0235770 A1
(43) Pub. Date: Sep. 24, 2009

(54) SWITCHING DEVICE FOR A GEARGOX

(75) Inventors: Josef Bader, Friedrichshafen (DE); Gerhard Birkenmaier, Tettnang-Waichesroute (DE); Kim Führer, Lindau (DE); Frank Gessler, Grünkraut (DE); Andreas Graf, Stockach-Wahlwies (DE); Kai Heinrich, Waldburg (DE); Karl-Fritz Heinzelmann, Meckenbeuren (DE); Gerhard Höring, Hagnau (DE); Hubert König, Meckenbeuren (DE); Ludger Ronge, Eriskirch (DE); Henrik Schuh, Friedrichshafen (DE); Mario Steinborn, Friedrichshafen (DE); Markus Ulbricht, Tettnang (DE); Manfred Vetter, Friedrichshafen (DE); Bernhard Walter, Friedrichshafen (DE); Klaus Wöhr, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/306,731

(22) PCT Filed: Jun. 6, 2007
(86) PCT No.: PCT/EP07/55571

§ 371 Date: Feb. 13, 2009

(30) Foreign Application Priority Data
Jun. 30, 2006 (DE) 10 2006 030 793.3

(51) Int. Cl. F16H 61/28

(52) U.S. Cl. 74/473.1

(57) ABSTRACT

A shift device (13) for a manual transmission having actuation mechanisms for shifting and selecting in which the selection motion is carried out by way of a selector actuator (10), which is connected to a driving lug (5) of a selector plate (4). An anchor (1) of the selector actuator (10) consists of a permanent magnet (2). End stops (3) of the selector actuator (10) are configured of ferromagnetic material, where the anchor (1) of the selector actuator (10) is fixed in a defined position for the installation of the selector actuator (10).

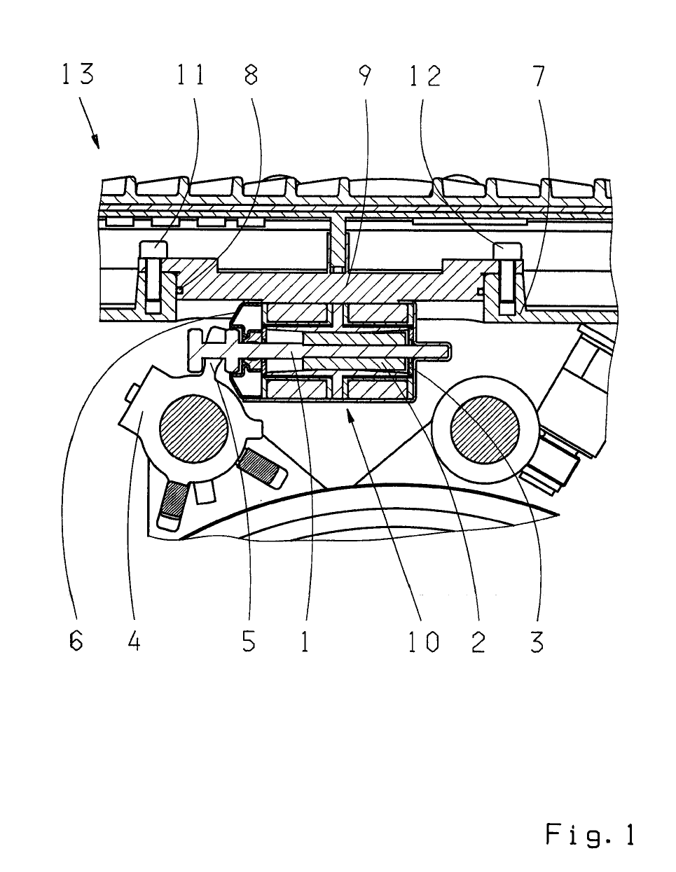

This application is a national stage completion of PCT/EP2007/055571 filed Jun. 6, 2007, which claims priority from German Application Serial No. 10 2006 030 793.3 filed Jun. 30, 2006.

### FIELD OF THE INVENTION

The invention concerns a shift device for a multi-speed manual transmission.

### BACKGROUND OF THE INVENTION

Automated transmissions consist with regard to their main components of conventional (if need be) manually actuable transmissions in which actuation of the shift and/or start up clutch, between the drive motor and transmission, as well as the selection and shifting of gears, is performed automatically via corresponding actuation mechanisms. These actuation mechanisms are usually configured as hydraulically or pneumatically actuable support cylinders or as electric actuators, which act on positioning means for the mentioned transmission functions. The positioning means can be arranged on or in the transmission. The main transmission can be configured herein in such a way that only one shift actuator is needed for the high force requirements of the shifting processes in utility vehicles, since the selection of corresponding shift elements can be realized by way of a selector actuator with low force requirements. These manual transmissions have a front-mounted group and/or a rear-mounted group in order to increase the number of gears of the main transmission.

Manual transmissions in which the shifting and selection of gears are performed by gear actuators are known from the state of the art. All actuation mechanisms, sensors, (magnetic) valves, as well as an electronic control device, required for performing a gearshift can be combined to shift in a mechatronic module in connection with a gear actuator. A gear actuator can be mounted separately in a corresponding recess of a transmission housing. The actuation mechanisms can be aligned, via suitable adjusting gauges, in such a way that the connection, between the piston rods of the actuation means and the gearshift rails, is produced when the gear actuator is inserted vertically in the transmission housing. The same applies accordingly for the connection of the selector device. EP 0 541 035 B1 discloses a transmission shifting system in which shifting and selection are implemented by a gear actuator, which can be mounted separately in a transmission housing.

It is a disadvantage in the state of the art that the actuation mechanisms, which are aligned via adjusting gauges, can be shifted once again during the installation of a gear actuator, where the engagement of the piston rods in recesses of the gearshift rails is made difficult or prevented.

In the unpublished application DE 10 2005 001 551.4 of the Applicant is described a shift device configured as a single rail shift device for a manual transmission with a selector and a shifting actuator, which comprises a selector shaft comprising shift forks or rockers that engage in sliding sleeves for shifting the gears. The content of this application is hereby incorporated by reference into the application in its entirety. The shifting motion can be implemented such that an axial motion of the selector shaft and the selection motion is kinematically decoupled from the shifting motion. The selector mechanism of the shift device includes a driver or shift finger ring, which is arranged on the selector shaft and is rotatable relative to it and is axially locked on the selector shaft. The driver or shift finger ring has a shift finger, which engages in corresponding grooves of the shift fork arms. Moreover, the selector mechanism has a selector plate or locking element, which can be driven by the selector actuator in the direction of rotation and is fixed on the housing, but which is not axially movable, which transmits the selection motion to the driver or shift finger ring and consequently to the shift finger. The shift forks or rockers of the gears, which are not to be shifted, are locked by way of this selector plate.

An object of the invention is to disclose a shift device for a manual transmission in which the installation of actuation mechanisms to be mounted on or in a transmission housing is made possible without difficulty without further equipment.

### SUMMARY OF THE INVENTION

The shift device of the invention has at least one actuation mechanism mounted separately on or in a transmission housing of a manual transmission. During the installation of the actuation mechanism on the transmission housing, the latter must engage in corresponding arrangements of a shift or selector mechanism. In order to ensure such an engagement, the actuation mechanism, as well as the shift or selector mechanism, must be brought into positions specified for this. An electrodynamic selector actuator will be adopted as actuation mechanisms in the following description.

A selector mechanism of the shift device includes a driver or shift finger ring arranged rotatably on the selector shaft and locked axially on the selector shaft, which has a shift finger. The selector mechanism has moreover a selector plate, which transmits the selection motion to the driver or shift finger ring and consequently to the shift finger. An element is arranged on the selector plate, for example a driving lug, which is preferably manufactured in one piece with the selector plate. The selector plate is fixed on the housing so as to be radially movable and axially fixed with regard to the selector shaft. An anchor of the selector actuator mounted on the transmission housing is connected to the driving lug of the selector plate. The driving lug and therewith also the selector plate are moved in circumferential direction relative to the selector shaft by actuating the selector actuator. The selector plate is designed in such a way that the shift forks or shift rockers of the gears, which are not to be shifted, are locked.

The anchor of the selector actuator is made from ferromagnetic material for a simple and secure installation of the selector actuator on the transmission housing. The anchor is fixed in a defined position by way of the ferromagnetic material (forced end position fixation). The housing of the selector actuator is arranged on a carrier plate or manufactured as one piece with the carrier plate. A sealing mechanism, which seals the interior transmission space off relative to the support space, for example an O-ring that encircles the carrier plate, is arranged on the carrier plate. When the selector actuator is installed, the anchor of the selector actuator is connected to the driving lug of the selector plate. Prior to installation of the selector actuator, the transmission is shifted into a defined gear, where the selector plate and consequently also the driving lug of the selector plate are also fixed in a defined position. The driving lug of the selector plate is visible from outside. The center of gravity of the selector plate can furthermore be designed in such a way that when the position of the transmission is horizontal, the driving lug is forced in the direction of the selector actuator, where the transmission does not need to be shifted into a defined gear prior to installation of the selector actuator. The selector actuator is engaged with a conical element. During the installation of the selector actuator, it is moved in vertical direction into a recess of the transmission housing, for example into an oblong hole recess. The position of the selector actuator and consequently also the position of the anchor of the selector actuator relative to the driving lug of the selector plate is predetermined by way of the recess on the transmission housing. With a vertical motion of the selector actuator in direction of the transmission housing, the latter comes into contact with the driving lug of the selector plate. The driving lug of the selector plate is forced in the direction of the anchor of the selector actuator by way of the conical element on the actuator housing. A secure engagement of the driving lug of the selector plate in the anchor of the selector actuator is ensured in this way. The carrier plate positioned on the transmission housing is connected in a fixed manner to the transmission housing by way of a screw connection.

Since the anchor of the selector actuator consists of a permanent magnet and the end stops of the selector actuator are made of ferromagnetic material, a fixation of the anchor in position is ensured, where no further equipment is needed for assembling the selector actuator. The selector actuator can be mounted on or in the transmission housing without any problems.

### BRIEF DESCRIPTION OF THE DRAWING

The invention will now be described, by way of example, with reference to the accompanying drawing in which:

A sole FIGURE depicts a cutout of a shift device 13 for a manual transmission.

### DETAILED DESCRIPTION OF THE INVENTION

Accordingly, an anchor 1 of a selector actuator 10 consists of a permanent magnet 2. When the selector actuator 10 is installed, the anchor 1 of the selector actuator 10 is connected to a driving lug 5 of a selector plate 4. A fixation of the anchor 1 in a position suitable for the installation of the selector actuator 10 is attained by configuring end stops 3 of the selector actuator 10 of ferromagnetic material to which the permanent magnet 2 is attracted (forced end position fixation). No further equipment is necessary for the installation of the selector actuator 10 in a defined gear for this reason so that the driving lug 5 of the selector plate 4, which must engage in the anchor 1 of the selector actuator 10, is visible from outside. The selector actuator 10 is sealed with a conical element 6. During the installation of the selector actuator, the latter is introduced in a vertical direction into a transmission housing 7. The position of the selector actuator 10 in longitudinal direction of the motor vehicle is predetermined by a recess in the transmission housing 7. The position of the anchor 1, relative to the driving lug 5 of the selector plate 4, is thus also predetermined in the motor vehicle longitudinal direction. The conical element 6 can press the driving lug 5 of the selector plate 4 in the direction of the anchor 1 for support or fine adjustment. The interior of the transmission space is sealed off, relative to the support space, by way of a sealing means 8 arranged on a carrier plate 9. This is necessary because the support space can have sensors, (magnetic) valves and an electronic control unit, among other things. This sealing mechanism 8 can be configured as an O-ring, which encircles the carrier plate 9. Once the selector actuator 10 has been completely introduced into the transmission recess, the carrier plate 9 of the selector actuator 10 fitted on the transmission housing 7 is connected in a fixed manner to the transmission housing 7. This connection can be realized by way of screw connections 11, 12, where the number of screw connections is not fixed at two. After installation of the selector actuator 10 in the transmission housing 7, the driving lug 5 of the selector plate 4 is introduced into the anchor 1, where the selection of a shifting lane is made possible. A blind assembly of the selector actuator 10 is simplified by way of the above-mentioned measures.

1-9. (canceled)

10. A shift device (13) for a manual transmission, having actuation means for shifting and selecting, in which a selection motion is carried out by way of a selector actuator (10), which is connected to a driving lug (5) of a selector plate (4) and whose anchor (1) comprises a permanent magnet (2), end stops (3) of the selector actuator (10) are configured of ferromagnetic material, whereby the anchor (1) of the selector actuator (10) is fixed in a defined position for installation of the selector actuator (10).

11. The shift device (13) for a manual transmission of claim 10, wherein the transmission is shifted, prior to installation of the selector actuator (10), into a defined gear.

12. The shift device (13) for a manual transmission of claim 10, wherein the selector actuator (10) is installed in a corresponding recess in a transmission housing (7).

13. The shift device (13) for a manual transmission of claim 10, wherein the driving lug (5) of the selector plate (4) is forced by a center of gravity of the selector plate (4), in a direction of the selector actuator (10), when the transmission is in a horizontal position.

14. The shift device (13) for a manual transmission of claim 10, wherein the selector actuator (10) is sealed with a conical element (6), and the driving lug (5) of the selector plate (4) is pressed in a direction of the anchor (1) during installation of the selector actuator (10).

15. The shift device (13) for a manual transmission of clam 10, wherein the selector actuator (10) seals off an interior space of the transmission in relation to a support space by way of an encircling sealing mechanism (8).

16. The shift device (13) for a manual transmission of claim 15, wherein the sealing mechanism (8) is an O-ring.

17. The shift device (13) for a manual transmission of claim 10, wherein the housing of the selector actuator (10) is one of supported on a carrier plate (9) or manufactured as one piece with the carrier plate (9).

18. The shift device (13) for a manual transmission of claim 10, wherein the selector actuator (10) introduced in the end position is connected in a fixed manner to the transmission housing (7) via the carrier plate (9) of the selector actuator (10) fitted on the transmission housing (7).

19. A shifting device (13) for a manual transmission, having an actuation means for shifting and selecting transmission gears, the shifting device comprising:
a selector actuator (10) having an anchor (1), which engages a driving lug (5) of a selector plate (4), for carrying out a gear selection motion, the anchor (1) comprising a permanent magnet (2) with end stops (3) of the selector actuator (10) comprising a ferromagnetic material, such that the anchor (1) is fixed within the selector actuator (10); and
the selector actuator (10) being fixed to a carrier plate (9), which is secured to a transmission housing (7), so that the selector actuator (10) is fixed in an interior of the transmission housing (7) and the anchor (1) engaging a driving lug (5) of a selector plate (4) for carrying out the gear selection motion, and the carrier plate (9) having a seal (8) for sealing the interior of the transmission from an exterior of the transmission.

20. A shifting device (13) for a manual transmission, having an actuator mechanism for selecting and shifting transmission gears, the shifting device comprising:
a selector actuator (10) having an anchor (1), which engages a driving lug (5) of a selector plate (4), for carrying out a gear selection motion, the anchor (1) comprising a permanent magnet (2) with end stops (3) of the selector actuator (10) comprising a ferromagnetic material such that the anchor (1) is fixed within the selector actuator (10); and
the selector actuator (10) being fixed to a carrier plate (9), which is secured to a transmission housing (7), so that the selector actuator (10) is fixed in an interior of the transmission housing (7) and the anchor (1) engages a driving lug (5) of a selector plate (4) for carrying out the gear selection motion, and the carrier plate (9) having a seal (8) for sealing the interior of the transmission from an exterior of the transmission.
